(19) United States
(12) Patent Application Publication
(10) Pub. No.: US 2011/0276473 A1
(43) Pub. Date: Nov. 10, 2011

(54) SYSTEM AND METHOD FOR FACILITATING EXCHANGE OF ESCROWED FUNDS

(75) Inventor: Cornelis Jan Blok, Amersfoort (NL)

(73) Assignee: DONAY BV, AMERSFOORT (NL)

(21) Appl. No.: 13/077,135

(22) Filed: Mar. 31, 2011

Related U.S. Application Data
(60) Provisional application No. 61/395,196, filed on May 10, 2010.

(51) Int. Cl. G06Q 40/00

(52) U.S. Cl. 705/39

(57) ABSTRACT

An electronic escrowed funds transfer system includes an escrow server in communication with a request client and a resource control client. The escrow server may include a funds management module to process and track funds being held in escrow, a resource management module to process a resource modification request, and a data repository module to store information relating to the request client, the resource control client, a resource to be modified, and/or the resource modification request. The resource modification request may be received by the escrow server and may include information relating to a location of the resource to be modified, an amount of funds to be paid for a modification of the resource, and/or a condition associated with the modification of the resource. The resource management module may transmit a notification upon receipt of the funds to the resource control client that a funded modification request has been received, and the resource management module may monitor a status of the modification of the resource to be modified to ensure that the condition has been met. The resource management module is in communication with the funds management module to release the funds to the resource control client upon determining that the condition has been met.

### RELATED APPLICATIONS

This application claims the benefit of U.S. Provisional Patent Application Serial No. 61/395,196 titled System and Method for Facilitating Exchange of Escrowed Funds filed on May 10, 2010, the entire contents of which are incorporated herein by reference.

### FIELD OF THE INVENTION

The present invention relates generally to escrow systems and, more specifically, to a system and method for releasing escrowed funds based on one or more monitored conditions of an online resource.

### BACKGROUND OF THE INVENTION

Currently there are a number of solutions for facilitating the transfer of monetary funds between a payor and a payee. Often a third-party financial intermediary is utilized to allow funds to be transferred between entities in a controlled manner. An escrow service is one such example of a third-party intermediary for facilitating the transfer of monetary funds. Known escrow systems however suffer from several deficiencies. Escrow systems are commonly used in situations where a first entity, the payor, is in need of a product or service to be provided or performed by a remotely located or untrusted second entity, the payee. Known systems typically require confirmation from the payor that the service has been completed or the product delivered in satisfactory condition before releasing monetary funds to the payee that performs the service or provides the product. This arrangement undesirably provides the payor with a disproportionate amount of control of the escrowed funds relative to the payee. The problem is particularly prevalent in the field of online content management or software development, where the payor, a person or entity desiring to see a change in or creation of an online resource (e.g. a change in an open-source software code repository) rarely knows or trusts the payee, the person or entity (e.g. a maintainer or contributor to an open-source software project) that will carry out the desired resource modification. Other escrow systems involve a verification step performed by another entity such as a shipping entity or installer that manually sends a confirmation that a product has been provided by a payee. The involvement of such an additional entity however undesirably adds cost and complexity.

It would be desirable to have a system for facilitating the exchange of escrowed funds that provides balanced control of the funds to both entities involved in the transaction, i.e., the payor and payee. Furthermore, it would be desirable to have an escrow system that does not require the involvement of an additional entity beyond the payee, the payor and the escrow service. Therefore, there currently exists a need in the industry for an improved escrow system.

### SUMMARY OF THE INVENTION

With the foregoing in mind, it is therefore an object of the present invention to provide a system and method for facilitating the exchange of escrowed funds in a secure manner. It is also an object of the present invention to provide a system and method that allows for the ready transfer of funds from a request client to a resource control client via an escrow server upon satisfaction of a condition. The present invention advantageously provides an electronic escrowed funds transfer system that ensures that the condition is met with respect to modification of the resource prior to releasing funds held in escrow. The system and method according to present invention further advantageously allows a request client to deposit funds into an escrow account along with a condition to be met with respect to the resource to be modified so that the resource that meets the condition can be located by the escrow server.

These and other objects, features and advantages according to the present invention are provided by an electronic escrowed funds transfer system that includes an escrow server in communication with a request client and a resource control client. The escrow server may comprise a funds management module to process and track funds being held in escrow, a resource management module to process a resource modification request, and a data repository module to store information relating to the request client, the resource control client, the resource to be modified, or the resource modification request.

The resource modification request may be received by the escrow server and may include information relating to a location of the resource to be modified, an amount of funds to be paid for modification of the resource, or a condition associated with the modification of the resource. The resource management module may transmit a notification upon receipt of the funds to the resource control client that a funded modification request has been received. The resource management module may monitor a status of the modification of the resource to ensure that the condition has been met. The resource management module may be in communication with the funds management module to release the funds to the resource control client upon determining that the condition has been met.

The resource management module may be positioned in communication with the funds management module to prevent release of the funds to the resource control client upon determining that the condition has not been met. Similarly, the resource management module may also return the funds to the request client upon determining that the condition has not been met within a predetermined time period. The escrow server may be positioned in communication with the resource control client and the request client through a communications network, and the resource control client may include a resource control client module and a user interface. Similarly, the request client may include a request client module. The resource control client module or the request client module, or both, may receive and display a notification that the funds have been released.

The escrow server may be positioned in communication with a financial entity, and the financial entity may hold the funds to be paid for the modification of the resource. The financial entity releases the funds to the resource control client in response to an indication from the escrow server that the condition has been met. The financial entity may also release the funds automatically to the resource control client in response to the indication from the escrow server that the at least one condition has been met.

The escrow server may deduct a commission amount from the funds to be paid for the modification of the resource prior to the funds being released to the resource control client. The commission amount may include a plurality of commission amounts. The condition associated with the modification of the resource may include a plurality of conditions. A percentage of the funds to be paid for the modification of the resource may be incrementally released upon completion of each of the plurality of conditions. Further, upon completion of each of the plurality of conditions, the funds available to be paid for the modification of the resource may be released to the resource control client. This advantageously allows for funds to be released to the resource control client upon completion of portions of the requested modification so that the resource control client does not have to wait to receive funds until after completion of the requested modification.

The resource may include an identifier related to the resource control client, and the resource management module may transmit a notification to the request client upon modification of the resource. The resource may also include an identifier relating to an account where the funds are to be deposited from escrow so that the funds may be deposited into the account upon the at least one condition being met. The account may be a plurality of accounts, and the funds may be deposited into the plurality of accounts based on a predetermined percentage split among the plurality of accounts.

The resource control client may be selected from a group of resource control clients, and the selected resource control client may be defined by the resource control client that has the resource to be modified that matches the condition set by the request client. This advantageously provides the request client with a plurality of options where the resource may be available.

The funds management module may receive the funds to be held in escrow from the request client and the resource management module may receive the condition relating to the resource to be modified from the request client. The escrow server may then search for the resource to be modified that meets the condition. This feature of the present invention advantageously eliminates much of the burden to locate the resource, i.e., instead of the request client spending time to locate a resource form a resource control client that may meet the condition, the request client can simply deposit the funds into the escrow account along with the conditions that are desired for the resource, and the resource can be located and modified for the request client, all while the request client is assured that the modified resource will have met the conditions that he/she has set.

A method aspect of the present invention is for transferring escrowed funds between a request client and a resource control client using the escrow server. The method may include processing and tracking the escrowed funds using the funds management module and processing a resource modification request received from the request client using the resource management module. The method may also include storing information relating to the request client, the resource control client, the resource to be modified, or the resource modification request using the data repository module. The method may further include receiving the resource modification request by the escrow server, which may include information relating to the location of the resource to be modified, an amount of funds to be paid for a modification of the resource, and/or the condition associated with the modification of the resource.

The method may still further include transmitting a notification upon receipt of the funds to the resource control client that a funded modification request has be received and monitoring a status of the modification of the resource to be modified to ensure that the condition has been met. The method may also include releasing the funds to the resource control client upon determining that the condition has been met.

### BRIEF DESCRIPTION OF THE DRAWINGS

FIG. 1 shows a block diagram illustrating an escrow system in accordance with an exemplary embodiment of the invention.

FIG. 2 shows another block diagram illustrating interaction between entities involved in the escrow system of FIG. 1.

FIG. 3 shows a flow diagram in accordance with an exemplary embodiment of the invention.

FIG. 4 shows a flow diagram in accordance with another embodiment of the invention.

FIG. 5 shows a flow diagram in accordance with another embodiment of the invention.

FIG. 6 is a diagram that shows an exemplary interface in accordance with the escrow system of FIG. 1.

FIG. 7 is a flow chart illustrating a method aspect according to an embodiment of the present invention.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notations refer to similar elements in alternate embodiments.

The present invention is directed to an escrow system configured to control escrowed funds based in part on one or more monitored conditions of an online resource. More specifically, the present invention is directed to an electronic escrowed funds transfer system that advantageously enhances security when transferring funds between a request client, i.e., a client that is requesting a modification of a particular resource, and a resource control client, i.e., a client that is in control of the particular resource for which the modification has been requested. More particularly, and by way of example, the present invention has many uses, but one particular advantageous use is to facilitate a trustworthy transaction to be handled online between two individuals in exchange for a resource modification. The resource may be any type of resource, e.g., media content, an online service, a product to be shipped to a requesting client, or any other type of good, product or service that may be available online.

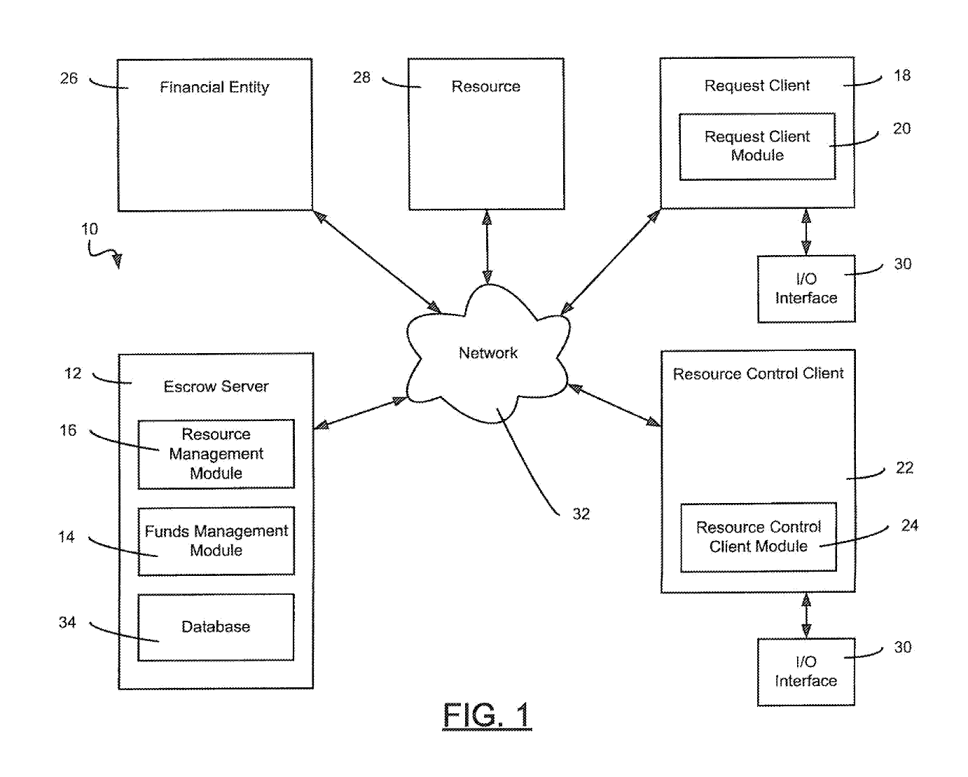

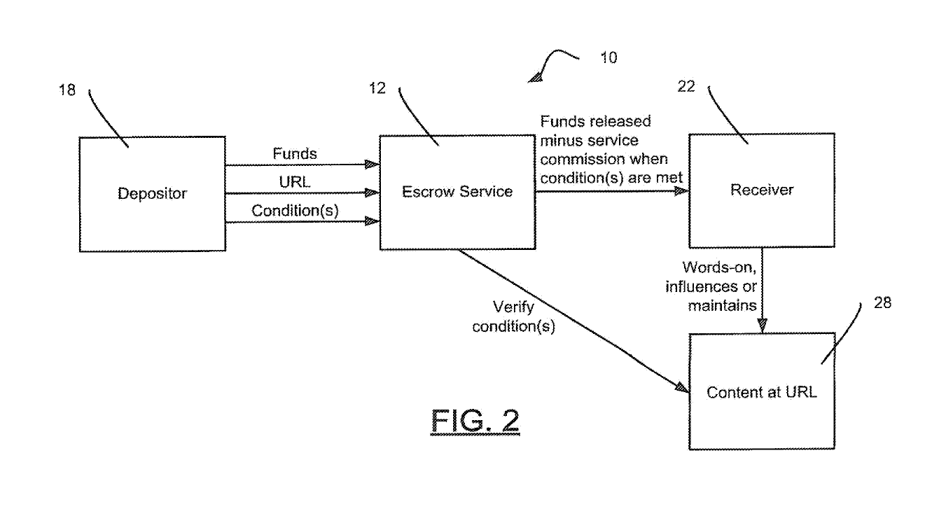

Referring to FIG. 1, a block diagram is shown illustrating an electronic escrowed funds transfer system 10 in accordance with an exemplary embodiment of the present invention. Throughout this disclosure, the electronic escrowed funds transfer system 10 may be referred to by several different names such as, but not limited to, “the system,” “escrow system” and other variations that the skilled artisan will readily recognize as being a reference to the present invention. Similarly, throughout this disclosure the terms “depositor,” “resource request client,” “requesting entity,” as well as other terms, may be interchangeably used to describe or refer to the request client 18. Further, throughout this disclosure, the terms “receiver,” “resource control client,” “receiving entity,” as well as other terms, may be interchangeably used to describe or refer to the resource control client. The terms “content,” “resource,” “resource URL” as well other terms are also interchangeably used to describe or refer to the resource 28. The interchangeability of the above terms is not meant in any way to be limiting. Instead, those skilled in the art will appreciate that these terms can be used while still accomplishing the goals, features and objectives according to the present invention. FIG. 2 is a block diagram illustrating interaction between various entities involved in the exemplary escrow system 10 of FIG. 1.

The escrow system 10 according to embodiments of the present invention includes an escrow server 12 device having program modules (labeled generally as “Escrow Service” in FIG. 2) including a funds management module 14 and a resource management module 16. The escrow server 12 may also have a data repository 34 for storing data (e.g. resource modification requests and user information). By way of example, the escrow server 12 may be a single computing device having a processor and memory or may include multiple computers communicatively coupled in a distributed cloud-based architecture.

The funds management module 14 is responsible for processing and tracking escrowed funds and/or fund notifications received from entities requesting a resource modification and/or financial institutions. As indicated above, a resource modification may, for example, be defined as any request to modify any type of resource 28, e.g., downloadable media. The funds management module 14 is also responsible for releasing or initiating the release of funds to entities responsible for performing resource modifications.

The resource management module 16 is responsible for processing resource modification requests. Each resource modification request may include information identifying the location (e.g. a URL/URI) of the resource 28 to be modified, the amount of funds to be paid for performing the requested modification, as well as one or more conditions associated with the desired modification. It is noted that a resource 28 may include content located at a particular URL, the content being any type of media such as text, audio, images or video. The resource management module 16 is also responsible for notifying the entity or entities responsible for the resource of receipt of a funded modification request and to subsequently monitor the resource until the desired modifications have been performed (i.e. the desired conditions have been met). The resource management module 16 communicates with the data repository 34 to store information associated with each entity, each resource being modified and the conditions associated with each requested modification. The resource management module 16 is also in communication with the funds management module 14 to initiate the transfer of funds to either the entity responsible for performing the desired modification or back to the requesting entity (e.g. when the conditions have not been met within a given time period).

The contemplated escrow system 10 according to embodiments of the present invention may also include one or more request clients 18 (labeled as “Depositor” in FIG. 2) and one or more resource control clients 22 (labeled as “Receiver” in FIG. 2). Each of the client devices are preferably communicatively coupled to the escrow server 12 by way of a network 32 such as the Internet. The request client 18 may include a request client module 20 and a user Input/Output (I/O) interface 30. The request client module 20 is responsible for receiving a resource modification request (e.g. via an interface displayed using the I/O interface) from a requesting entity along with the associated funds to be placed in escrow, and for sending the request to the escrow server 12. The resource control client 22 may include a resource control client module 24 and a user Input/Output (I/O) interface 30. The resource control client module 24 is responsible for receiving and displaying notifications from the escrow server 12 that a resource modification request has occurred, for modifying the online resource, and for receiving notifications that escrowed funds have been released by the escrow server 12.

By way of example, each of the clients may be a computing device having a processor and memory such as personal computer, a phone, a mobile phone, or a personal digital assistant. The client I/O interfaces 30 may include a keyboard, mouse, monitor, touch screen or similar interface device suitable for allowing a user to interact with the client devices. The contemplated escrow system 10 according to the present invention may also include one or more financial entities 26 for facilitating the exchange of monetary funds between the escrow server 12, entities requesting resource modifications and entities performing, the desired resource modifications. To be specific, the system 10 according to the present invention does not necessarily require a financial entity 26. Instead, a financial entity 26 is a contemplated option. The skilled artisan will appreciate, after having had the benefit of this disclosure, that the system 10 according to the present invention can still accomplish the goals, objectives and advantages of securely transferring funds via an escrow server 12 between a request client 18 and a resource control client 22 without the inclusion of a financial entity 26.

The financial entities 26 may, for example, include a financial intermediary such as PayPal, or any other financial intermediary as understood by those skilled in the art. It is noted that any financial intermediary suitable for receiving funds from entities requesting resource modifications or for transmitting escrowed funds to entities performing desired resource modifications may be used. Financial intermediaries that allow funds to be transferred based on an e-mail address (e.g. PayPal) or via mobile phone (e.g. Nokia) may be used. The escrow server 12 of the system 10 according to the present invention may alternatively be configured to act as such a financial intermediary. Each of financial entities 26 is communicatively coupled to the escrow server 12 and each of the client entities by way of a network 32 such as the Internet.

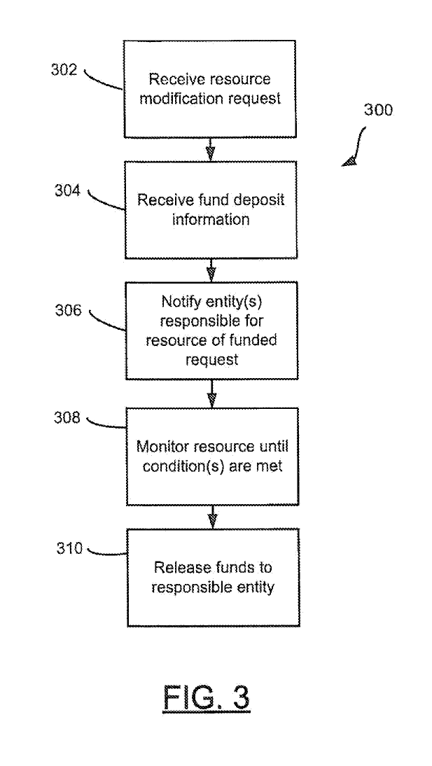

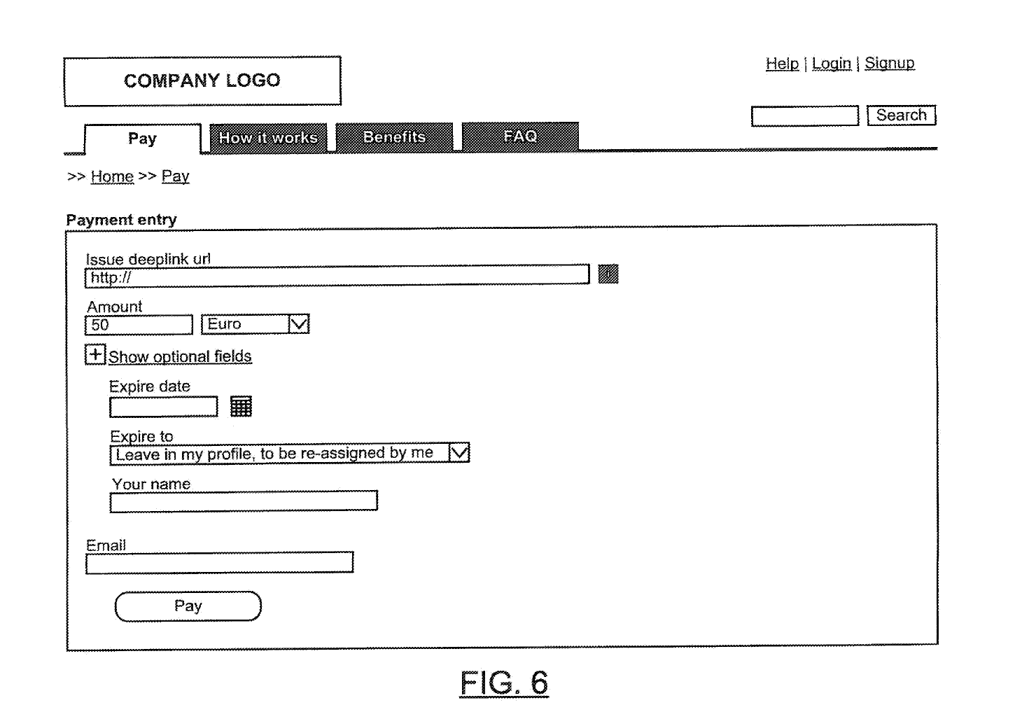

Referring now to FIG. 3, a flow diagram 300 in shown that illustrates a computer-implemented process or method that may be carried out with the contemplated escrow system. FIG. 6 illustrates an interface diagram that will also be referred to. The process illustrated in the flowchart 300 of FIG. 3 begins when the escrow server receives a modification request from a requesting entity at Block 302. By way of example, the modification request may originate from a request client device 18 adapted to receive modification request information from the requesting entity. FIG. 6 illustrates an exemplary interface that may be displayed to the requesting entity for receiving such modification request information.

Upon receipt of a modification request at Block 302, the resource management module 16 processes and stores the modification request information, which includes the location (e.g. as a URL) of the resource to be modified, the amount of funds to be paid for performing the requested modification, as well as one or more conditions associated with the desired modification request. By way of non-limiting example, the conditions may include the following (note that “X” represents content found at the resource location and “Y” represents desired content as defined by the requesting entity):
detecting the presence of content at the resource location (X), detecting that content does not exist at the resource location (!X);
detecting that the content matches the desired content (X=Y), detecting that the content does not match the desired content (X!=Y);
detecting the presence of added content (Y in X) such as the presence of a new segment of text;
detecting the removal of an existing segment of content (! (Y in X)) such as the removal of a particular segment of text;
detecting that the existing content is larger than the desired content (X>Y) and/or determining that the existing content is smaller than the desired content (X<Y).

Such conditions may be defined to monitor text content or other multi-media content such as audio or video data. The requesting entity may enter the modification request information by way of an interface (see FIG. 6) displayed on one of the client devices. The interface may also be configured to allow the requesting entity to select the type of condition to be monitored and to define attributes associated with the selected condition. It is noted that such conditions may include any type of verifiable information (e.g. a string, a number or a Boolean flag) suitable for indicating that a resource has been modified in the desired manner.

By way of example, the interface may include one or more controls (e.g. a combobox) for selecting the type of condition to be monitored. The interface may also include one or more interface controls (e.g. a textbox or combobox) for allowing the requesting entity to define attributes to be used in determining whether each condition has been met. A text box control, for example, may be provided for receiving a segment of text associated with the desired resource change. The segment of text may be compared (e.g. by performing string or Boolean comparison logic) with text found at the resource location to determine whether the desired condition has been met. The conditions may also comprise constraints related to the manner in which the requested modification is carried out. The constraints may, also for example, include a time frame within which the requested modification must be completed (shown as an optional field in FIG. 6).

After the modification request has been processed, the funds management module 14 may await receipt of funds from the requesting entity or for a notification (e.g. from a financial intermediary) that funds have been deposited by the requesting entity 18 in the amount specified in the modification request (Block 304). Once the funds management module receives confirmation that the funds have been deposited, the resource management module 16 then sends a notification to one or more entities 22 responsible for the resource desired to be modified. In other words, the entities 22 responsible for the resource may be notified that a funded request has been received (Block 306). The entity/entities responsible for the resource 28 may, for example, be a person, a group of people or an organization that maintains or is otherwise able to modify or influence content found at the resource. The resource management module 16 identifies the entity/entities responsible for the resource 28 by parsing the content found at the resource to determine contact information. The contact information may include hosting information, mailing list information, forum information, one or more email addresses, or one or more phone numbers. The entity requesting the modification may alternately provide the contact information (e.g. e-mail address or mobile phone number) associated with the entity/entities responsible for the resource if the requesting entity has knowledge of the contact information prior to making the modification request.

Entities 22 responsible for a resource may alternatively register with the escrow server 12 (e.g. provide URL/contact mapping information) to allow the resource management module 16 to look up the contact information based on the resource location provided by the requesting entity. The escrow server 12 may also issue an identification number to registered entities which may then be embedded in the resource for which the registered entity is responsible. This allows the escrow server 12 to advantageously verify the identity of the registered entity and facilitates payment processing. The notification may, for example, be sent by e-mail, phone, by posting the notification to a forum or by posting the notification to a mailing list. Those skilled in the art will appreciate that any type of notification may be provided while still accomplishing the goals, features and objectives according to the present invention.

The notification message may include the received conditions, the location of the resource (e.g. a URL) and the amount of funds placed in escrow for making the requested modification. The resource management module 16 may then monitor the resource 28 at regular intervals to determine if any of the one or more conditions have been met (Block 308) and releases the escrowed funds when each of the one or more conditions have been met (Block 310). For example, the resource management module 16 may monitor the resource and either disperse all of the escrowed funds upon completion of all of the conditions, or portions of the escrowed funds as portions of the conditions are being met, i.e., incrementally dispersing the funds as the conditions are met.

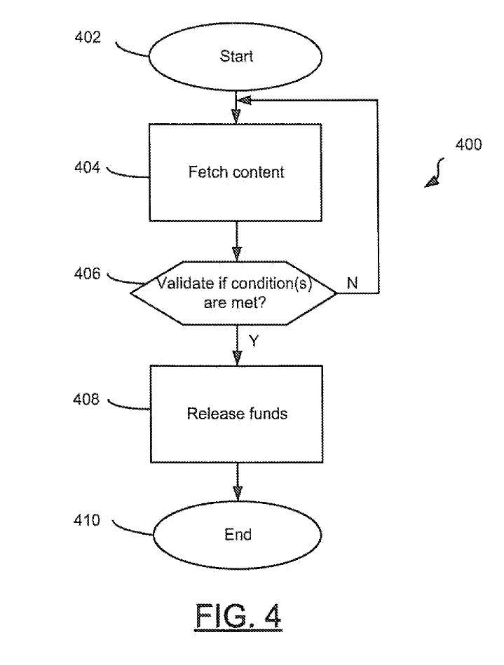

The flow chart 400 illustrated in FIG. 4 also illustrates the processing carried out at the monitoring step as will now be discussed in greater detail. The monitoring may be carried out by downloading the content associated with the monitored resource at regular intervals and in an automated manner, similar to the processing performed by a web reader/crawler (also known as a “web spider” or “bot”). Each time the content is downloaded, the resource management module carries out processing associated with each of the one or more conditions to determine if each condition has been met. Resource protocol handler result codes (e.g. code 200=means found, code 404=not found for HTTP URL resources) may be used to indicate results of condition updates that relate to detecting the presence or addition of content. Accordingly, from the start (Block 402) the content that is desired by the requesting entity is fetched at Block 404.

At Block 406, it is determined whether or not the conditions set by the requesting entity have been met, i.e., the conditions are validated. If it is determined at Block 406 that the conditions have not been met, i.e., not validated, then the content is again fetched at Block 404. After determining at Block 406 that each condition has been met, the escrow management module then determines which entity was responsible for performing the requested modification. The entity responsible for performing the requested modification is determined by similar means described above with regard to determining the one or more entities responsible for maintaining or influencing the online resource. Once the entity responsible for performing the requested modification has been determined the escrow management module then initiates the release of escrowed funds to the responsible entity at Block 410.

By way of example, the escrowed funds may be stored in a third party financial account (e.g. a PayPal or Google Checkout account maintained by the escrow server) and released to the responsible entity by way of an e-mail address or phone number associated with the responsible entity. The responsible entity is then able to claim the escrowed funds by way of the third party financial service. It is noted that the requesting entity does not control the release of funds once the funds has been placed in escrow and the modification request has been provided. Triggering the release of funds is thus impartially performed by the escrow server in an automated manner.

It is also noted that the escrow server 12 monitors the resource over a predetermined period of time to ensure that the modification has taken place. The predetermined period of time may be set by the requesting entity, or may be preset by the escrow server 12. If the resource is not modified within the predetermined amount of time, the escrowed funds may be returned to the requesting entity. Alternately, the escrowed funds may be retained by the escrow server until the content (resource) can be located that does meet the conditions set by the request client 18. This is an optional feature and may advantageously allow the request client the flexibility to deposit the escrowed funds in search of the desired resource and not have to think about it again until the resource is located that meets the desired conditions.

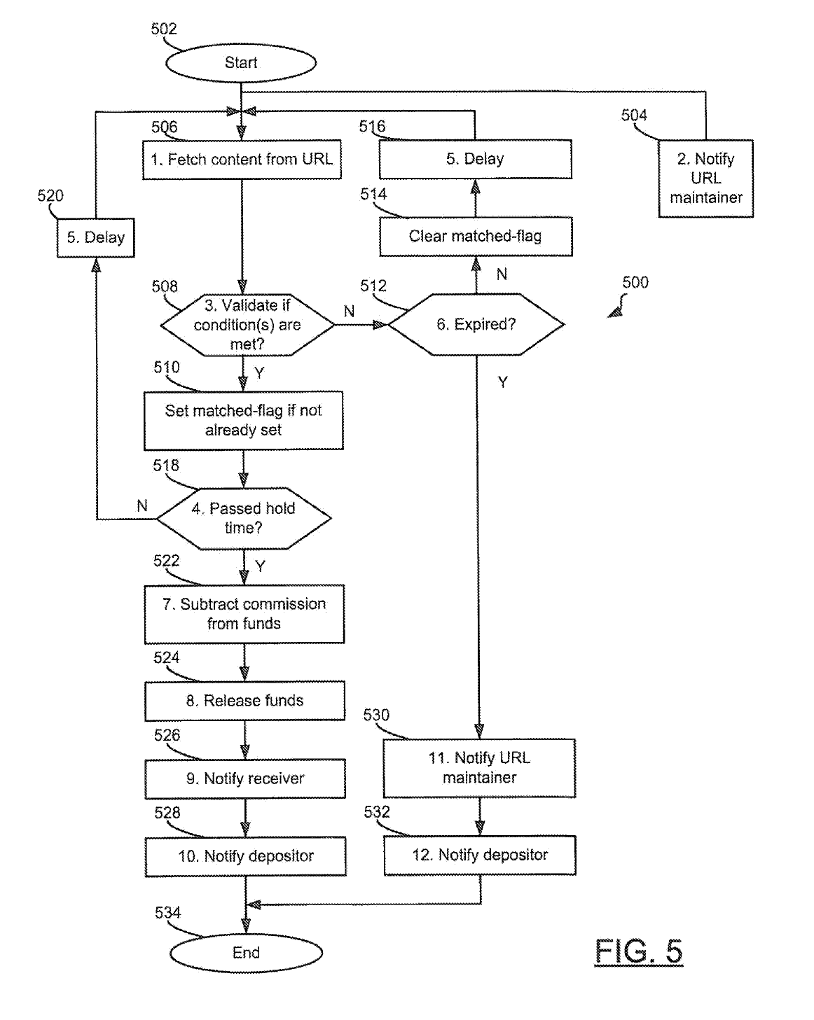

A flowchart 500 is illustrated in FIG. 5 and depicts processing steps that may be carried out by the exemplary escrow system according to the present invention. As shown, the resource management module may support a holding period, which occurs prior to releasing escrowed funds. The holding period is a predetermined period of time provided to mitigate the risk of a premature release of funds to the entity responsible for carrying out the desired modification. By way of example, the holding period may be approximately one day, but those skilled in the art will appreciate that the holding period may be any length of time. The resource management module may also include a step of determining whether the escrowed funds have expired, e.g. when a time constraint has passed. This check may be carried out each time the resource is visited by the resource management module.

After determining that the funds have expired, the resource management module 14 may then notify the entity or entities responsible 22 for the online resource 28 as well as the entity 18 requesting the modification that the funds have been refunded back to the requesting entity. The escrow server may also perform a step of retaining a percentage of the escrowed funds as payment for providing the contemplated escrow service. The escrow server may carry out this step prior to releasing the escrowed funds to the entity responsible for making the desired modification. To retain a portion of the escrowed funds the resource manager may first determine a commission by multiplying the total amount of the funds to be paid to the entity responsible for making the desired modification by a predetermined percentage (e.g. five percent). The funds management module then retains the commission. It is noted that the resource manager may alternately perform the determining step when the funds are initially requested, in order to secure the funds from the requesting entity prior to providing the contemplated service. After releasing the funds to the responsible entity the resource management module may then notify both the responsible entity and the requesting entity that the funds have been successfully released.

Referring again to the flowchart 500 FIG. 5, additional details are now provided with respect to the method aspect of the present invention. From the start (Block 502), a URL maintainer 22 is notified of a resource request from a request client at Block 504. The resource is then fetched from the URL at Block 506. Thereafter, it is determined at Block 508 whether or not the conditions associated with the resource modification request that are set by the request client have been met at Block 508. If it is determined at Block 508 that the condition has not been met, then it is determined at Block 512 whether or not a predetermined time frame has expired. If it is determined at Block 512 that a predetermined timeframe has not expired, then the matched flag is cleared at Block 514 and a delay in instituted at Block 516. The content is again fetched at Block 506. Fetching the content at Block 506 indicates that the system 10 searches for content that preferably meets all the conditions. If it is determined, however, at Block 512 that the predetermined time has expired, then the URL maintainer is notified at Block 530, the depositor 18 is notified at Block 532, and the process is ended at Block 534.

If it is determined at Block 508 that the condition set by the request client has been met, then an indication is provided at Block 510 that the condition has been met. The indication may, for example, be a matched flag that is set, but those skilled in the art will appreciate that any indication can be provided. Thereafter, it is determined at Block 518 whether or not the hold time for receiving the content has been exceeded. If it is determined at Block 518 that the hold time has not been exceeded, then, additional hold time is provided at Block 520, and the content is again fetched at Block 506.

If, however, it is determined at Block 518 that the hold time has been exceeded, then a commission may be subtracted from the escrowed funds at Block 522, and the funds may be released at Block 524. The receiver may be notified of the release of the funds at Block 526 and the depositor 18 may be notified of the release of the funds at Block 528. Thereafter, the method may be ended at Block 534.

The funds management module may receive the funds to be held in escrow from the request client and the resource management module may receive the condition relating to the resource to be modified from the request client. In an alternate embodiment of the present invention, the escrow server may then search inside the resource content, or related resource content, for contact information relating to the resource control client. This feature of the present invention advantageously eliminates much of the burden that may be associated with locating the resource control client. Accordingly, time that may be spent by the request client in locating for the resource control client is advantageously eliminated. The request client can simply deposit the funds into the escrow account along with the conditions that are desired for the resource, all while the request client is assured that the modified resource will have met the conditions that he/she has set upon release of the funds.

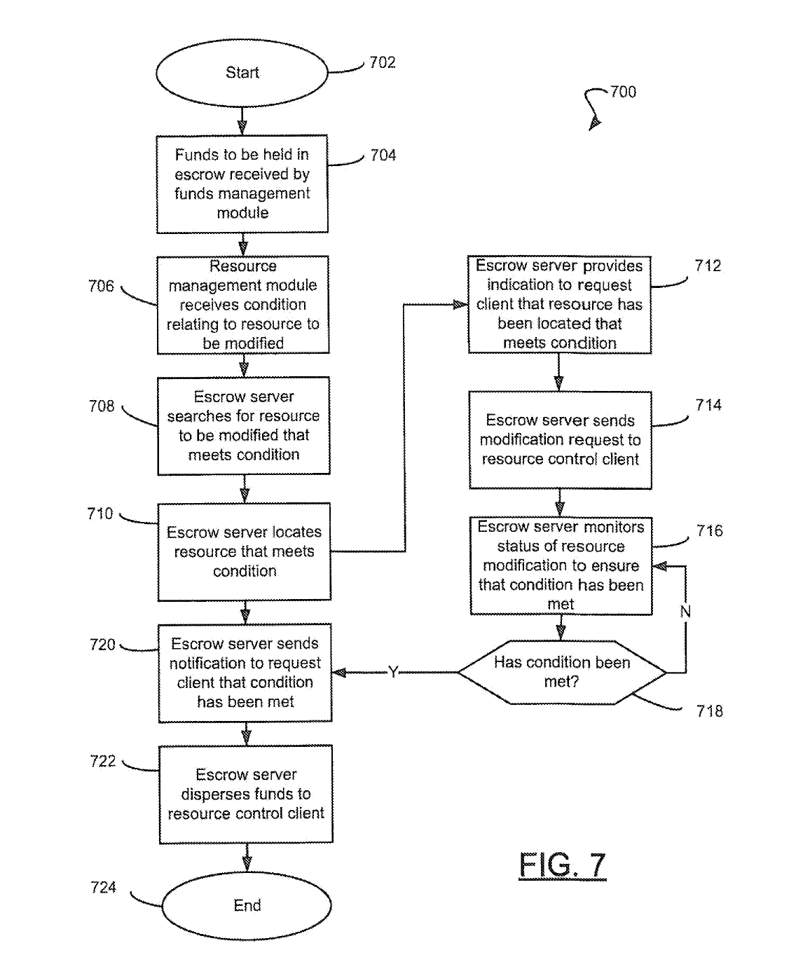

Referring now additionally to the flowchart 700 illustrated in FIG. 7, an additional method aspect according to an embodiment of the present invention is now described in greater detail. From the start (Block 702) funds that are to be held in escrow are received by the funds management module at Block 704. At Block 706, the resource management module receives a condition (or multiple conditions) relating to the resource that is desired to be modified. The escrow server of the escrow system according to the present invention searches for the resource to be modified that meets the condition at Block 708. At Block 710, the escrow server locates the resource that meets the condition. The escrow server then provides an indication to the request client that the resource that meets the condition has been located at Block 712. Those skilled in the art will appreciate that the notification provided in Block 712 is an optional notification and that the method aspect of the present invention can still be carried out without providing a notification to the request client that the resource has been located.

At Block 714, the escrow server sends the modification request to the resource control client. The modification request preferably includes an indication that the funds have been deposited into escrow, and the conditions that are being requested with respect to modification of the resource. At Block 716, the escrow server monitors a status of the resource modification to ensure that the condition set by the request client has been met.

At Block 718, it is determined whether or not the condition has been met. If it is determined at Block 718 that the condition has not been met, then the escrow server again monitors the status of the resource modification to ensure that he condition has been met at Block 716. If, however, it is determined at Block 718 that the condition has been met, then the escrow server sends a notification to the request client that the condition has been met at Block 720. Again, similar to the notification discussed with reference to Block 712, the notification described in Block 720 is an optional notification and the system according to the present invention can operate to securely transfer funds via an escrow server between a request client and a resource control client without the need to transmit a notification to the request client that the condition has been met. The escrow server may disperse the funds at Block 722 and the process may be ended at Block 724.

Those skilled in the art will appreciate that the escrow system 10 according to the present invention contemplates more than one type of notification. For example, the escrow system according to the present invention may provide a notification to the request client that their funds and associated conditions have been receive by the escrow server. The system 10 may also provide a notification to a resource control client of a requested modification to a resource. The notification may indicate that the requested modification is a funded request or an unfunded request. The notification can also indicate that the amount of funding available, which advantageously provides the resource control client with the ability to determine whether or not they are willing to accept a request for a modification of a resource for the price that is indicated. The system may also include a modification notification to inform the resource control client and the request client that the resource has been modified. These notifications can be combined or separate.

Those skilled in the art will also appreciate that the system 10 according to embodiments of the present invention contemplates that both the request client and the resource control client may be kept confidential. In such a case, both the request client and the resource control client may be provided with the option to determine whether or not they desire to engage in an exchange with a party that desires to remain anonymous. Further, and by way of example, one of the conditions that may be set by the request client may be that the resource control client not be one that remains anonymous.

As discussed, the contemplated escrow system 10 may be used in the field of online content management or software development to allow an entity desiring to see a change in, or creation of, an online resource (e.g. a change in an open-source software code repository) to pay a potentially unknown or un-trusted entity (e.g. a maintainer or contributor to an open-source software project) to carry out the desired resource modification in a controlled manner. With regard to use in software development, the contemplated system may be used to incentivize feature requests or bug fixes, resources that are often tracked via an issue tracking system. The contemplated escrow system 10 may be employed by such an issue tracking system in a number of ways. The escrow system may be used independently from the issue tracking system as previously discussed. The issue tracking system may alternately integrate the capabilities of the resource management module and funds management module implemented by the escrow server. An issue tracking system may also operate in conjunction with the contemplated escrow system by embedding within each resource (e.g. a URL associated with a tracked issue) an interface control mechanism (e.g. a button) configured to automatically generated a resource modification request.

The interface control mechanism may contain at least a portion of the information (e.g. the URL of the resource or issue, or the contact information of the entity responsible for the resource, and/or the desired conditions) required for generating the modification request. Upon selecting (e.g. clicking) the control mechanism, the requesting entity may be prompted to supply any additional information (e.g. entity name and the amount of funds to be placed in escrow) for generating the modification request. The modification request is then sent to the escrow server and processed as previously discussed. The process of generating a modification request is therefore greatly simplified for the entity desiring to request a resource modification. The interface control mechanism may be created by the issue tracking system or may be remotely embedded by the escrow management server.

It is noted that in addition to the fields of online content management or software development, the contemplated escrow system 10 may be utilized in a variety of other settings. By way of example, the escrow system according to the present invention could be employed in an advertising context. In such a context, a first entity may desire to pay a second entity for online advertising. In order to ensure that the second entity continually displays an advertising banner or link, the URL where the ad is placed may be continually monitored for an embedded code signaling active display of the banner or link. If the banner or link is present then escrowed funds may be released in the manner described above.

This could be done iteratively at pre-defined intervals. A similar scenario could also be contemplated for testing, verifying and paying for when content is live on the Internet. The escrow system could also be used in a blog or newspaper setting where article placement is paid for as long as the article appears on a certain page. Similarly, the invention could be used for document creation in an online environment. For example, a patent attorney working on a patent application could be automatically paid through the authorized release of payments upon certain metrics being met, where documents are created in an Internet or Intranet environment and probed, tested and verified that they are complete to a certain threshold level. The contemplated escrow system 10 according to the present invention can be set up and used in any scenario where scanning for metrics or verifiable conditions can be accomplished, which when those metrics or conditions are met cause a payment to be triggered. For example, when a first condition or metric is met, a first percentage (e.g. 10%) of the escrowed funds is released; when a second condition or metric is met, a second percentage (e.g. another 10%) of the escrowed funds is released; and so on, until a final condition or metric is met and a final percentage of the escrowed funds is released. These percentages are illustrative only.

The various illustrative program modules and steps described in connection with the embodiments disclosed herein may be implemented as electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, CPU, controller, microcontroller, programmable logic device, array of logic elements, or state machine. The software module may reside in RAM memory, flash memory, ROM memory, EPROM memory, EEPROM memory, hard disk, a removable disk, a CD, DVD or any other form of storage medium known in the art. An exemplary processor may be coupled to the storage medium so as to read information from, and write information to, the storage medium. In the alternative, the storage medium may be integral to the processor.

In further embodiments, those skilled in the art will appreciate that the foregoing methods can be implemented by the execution of a program embodied on a computer readable medium. The medium may comprise, for example, RAM accessible by, or residing within the device. Whether contained in RAM, a diskette, or other secondary storage media, the program modules may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

That which is claimed is:

1. An electronic escrowed funds transfer system comprising:
an escrow server in communication with at least one request client and at least one resource control client, the escrow server comprising
a funds management module to process and track funds being held in escrow,
a resource management module to process at least one resource modification request, and
a data repository module to store information relating to at least one of the at least one request client, the at least one resource control client, a resource to be modified, and the at least one resource modification request
wherein the at least one resource modification request is received by the escrow server and includes information relating to at least one of a location of the resource to be modified, an amount of funds to be paid for a modification of the resource, and at least one condition associated with the modification of the resource;
wherein the resource management module transmits a notification upon receipt of the funds to the at least one resource control client that a funded modification request has been received;
wherein the resource management module monitors a status of the modification of the resource to be modified to ensure that the at least one condition has been met; and
wherein the resource management module is in communication with the funds management module to release the funds to the at least one resource control client upon determining that the at least one condition has been met.

2. A system according to claim 1 wherein the resource management module is in communication with the funds management module to prevent release of the funds to the at least one resource control client upon determining that the at least one condition has not been met.

3. A system according to claim 1 wherein the resource management module is in communication with the funds management module to return the funds to the at least one request client upon determining that the at least one condition has not been met within a predetermined time period.

4. A system according to claim 1 wherein the escrow server is in communication with the at least one resource control client and the at least one request client through a communications network; wherein the at least one resource control client includes a resource control client module and a user interface; and wherein the at least one request client includes a request client module and a user interface.

5. A system according to claim 4 wherein at least one of the resource control client module and the request client module receives the notifications.

6. A system according to claim 4 wherein the notifications are displayed to at least one of the resource control client and the request client via the user interface.

7. A system according to claim 1 wherein the escrow server is in communication with at least one financial entity; and wherein the at least one financial entity holds the funds to be paid for the modification of the resource.

8. A system according to claim 7 wherein the at least one financial entity releases the funds to the at least one resource control client in response to an indication from the escrow server that the at least one condition has been met.

9. A system according to claim 8 wherein the at least one financial entity releases the funds automatically to the at least one resource control client in response to the indication from the escrow server that the at least one condition has been met.

10. A system according to claim 1 wherein the escrow server deducts a commission amount from the funds to be paid for the modification of the resource prior to the funds being released to the at least one resource control client.

11. A system according to claim 10 wherein the commission amount includes a plurality of commission amounts.

12. A system according to claim 1 wherein the at least one condition associated with the modification of the resource includes a plurality of conditions; wherein a percentage of the funds to be paid for the modification of the resource are incrementally released upon completion of each of the plurality of conditions.

13. A system according to claim 12 wherein upon completion of each of the plurality of conditions, the funds available to be paid for the modification of the resource are released to the at least one resource control client.

14. A system according to claim 1 wherein the resource includes at least one identifier related to the at least one resource control client;
and wherein the resource management module transmits a notification to the at least one request client upon modification of the resource.

15. A system according to claim 1 wherein the resource includes at least one identifier relating to at least one account where the funds are to be deposited from escrow; and wherein the funds are deposited into the at least one account upon the at least one condition being met.

16. A system according to claim 15 wherein the at least one account includes a plurality of accounts; and wherein the funds are deposited into the plurality of accounts based on a predetermined percentage split among the plurality of accounts.

17. A system according to claim 1 wherein the at least one resource control client is selected from a group of resource control clients; and wherein the at least one resource control client that is selected from the group of resource control clients is defined by the at least one resource control client that has the resource to be modified that matches the at least one condition.

18. A system according to claim 1 wherein the funds management module receives the funds to be held in escrow from the at least one request client; and wherein the resource management module receives the at least one condition relating to the resource to be modified from the at least one request client; and wherein the escrow server searches for the resource to be modified that meets the at least one condition.

19. A method of transferring escrowed funds between at least one request client and at least one resource control client using an escrow server that is in communication with the at least one request client and the at least one resource control client, the escrow server comprising a funds management module, a resource management module and a data repository module, the method comprising:
processing and tracking the escrowed funds using the funds management module;
processing at least one resource modification request received from the at least one request client using the resource management module;
storing information relating to at least one of the at least one request client, the at least one resource control client a resource to be modified, and the at least one resource modification request using the data repository module;
wherein the at least one resource modification request is received by the escrow server and includes information relating to at least one of a location of the resource to be modified, an amount of funds to be paid for a modification of the resource, and at least one condition associated with the modification of the resource;
transmitting a notification upon receipt of the funds to the at least one resource control client that a funded modification request has be received;
monitoring a status of the modification of the resource to be modified to ensure that the at least one condition has been met; and
releasing the funds to the at least one resource control client upon determining that the at least one condition has been met.

20. A method according to claim 19 wherein the step of releasing the funds to the at least one resource control client is prevented upon determining that the at least one condition has not been met.

21. A method according to claim 19 further comprising returning the funds to the at least one request client upon determining that the at least one condition has not been met within a predetermined time period.

22. A method according to claim 19 wherein the escrow server is in communication with the at least one resource control client and the at least one request client through a communications network; wherein the at least one resource control client includes a resource control client module and a user interface; and wherein the at least one request client includes a request client module and a user interface.

23. A method according to claim 22 wherein at least one of the resource control client module and the request client module receives the notifications.

24. A method according to claim 22 wherein the notifications are displayed to at least one of the resource control client and the request client via the user interface.

25. A method according to claim 19 wherein the escrow server is in communication with at least one financial entity; and wherein the at least one financial entity holds the funds to be paid for the modification of the resource.

26. A method according to claim 25 wherein the at least one financial entity releases the funds to the at least one resource control client in response to an indication from the escrow server that the at least one condition has been met.

27. A method according to claim 25 wherein the at least one financial entity releases the funds automatically to the at least one resource control client in response to the indication from the escrow server that the at least one condition has been met.

28. A method according to claim 19 further comprising deducting a commission amount from the funds to be paid for the modification of the resource prior to the funds being released to the at least one resource control client.

29. A method according to claim 28 wherein the commission amount includes a plurality of commission amounts.

30. A method according to claim 19 wherein the at least one condition associated with the modification of the resource includes a plurality of conditions; and further comprising incrementally releasing a percentage of the funds to be paid for the modification of the resource upon completion of each of the plurality of conditions.

31. A method according to claim 30 wherein, upon completion of each of the plurality of conditions, the funds available to be paid for the modification of the resource are released to the at least one resource control client.

32. A method according to claim 19 wherein the resource includes at least one identifier related to the at least one resource control client; and further comprising transmitting a notification to the at least one request client upon modification of the resource.

33. A method according to claim 19 wherein the resource includes at least one identifier relating to at least one account where the funds are to be deposited from escrow; and further comprising depositing the funds into the at least one account upon the at least one condition being met.

34. A method according to claim 33 wherein the at least one account includes a plurality of accounts; and further comprising depositing the funds into the plurality of accounts based on a predetermined percentage split among the plurality of accounts.

35. A method according to claim 19 wherein the at least one resource control client is selected from a group of resource control clients; and
wherein the at least one resource control client that is selected from the group of resource control clients is defined by the at least one resource control client that has the resource to be modified that matches the at least one condition.

36. A method according to claim 19 further comprising receiving the funds to be held in escrow from the at least one request client; receiving the at least one condition relating to the resource to be modified from the at least one request client; and searching for the resource to be modified that meets the at least one condition.

37. A method of transferring escrowed funds between at least one request client and at least one resource control client that are in communication with one another via a network, wherein the escrowed funds are transferred using an escrow server that is in communication with the at least one request client and the at least one resource control client through the network, the escrow server comprising a funds management module, a resource management module and a data repository module, wherein the resource control client includes a resource control client module and a user interface, the method comprising:
processing and tracking the escrowed funds using the funds management module;
processing at least one resource modification request received from the at least one request client using the resource management module;
storing information relating to at least one of the at least one request client, the at least one resource control client, a resource to be modified, and the at least one resource modification request using the data repository module;
transmitting a notification upon receipt of the funds to the at least one resource control client that a funded modification request has be received;
monitoring a status of the modification of the resource to be modified to ensure that the at least one condition has been met;
releasing the funds to the at least one resource control client upon determining that the at least one condition has been met; and
wherein the at least one resource modification request includes information relating to at least one of a location of the resource to be modified, an amount of funds to be paid for a modification of the resource, and at least one condition associated with the modification of the resource;
wherein the escrow server is in communication with at least one financial entity; and wherein the at least one financial entity holds the funds to be paid for the modification of the resource.

38. A method according to claim 37 wherein the step of releasing the funds to the at least one resource control client is prevented upon determining that the at least one condition has not been met.

39. A method according to claim 37 further comprising returning the funds to the at least one request client upon determining that the at least one condition has not been met within a predetermined time period.

40. A method according to claim 37 further comprising receiving and displaying the notifications via at least one of a message being transmitted to at least one of the resource control client and the request client, and by accessing the notification via a user interface.

41. A method according to claim 37 wherein the at least one financial entity releases the funds to the at least one resource control client in response to an indication from the escrow server that the at least one condition has been met.

42. A method according to claim 37 wherein the at least one financial entity releases the funds automatically to the at least one resource control client in response to the indication from the escrow server that the at least one condition has been met.

43. A method according to claim 37 further comprising deducting a commission amount from the funds to be paid for the modification of the resource prior to the funds being released to the at least one resource control client.

44. A method according to claim 43 wherein the commission amount includes a plurality of commission amounts.

45. A method according to claim 37 wherein the at least one condition associated with the modification of the resource includes a plurality of conditions; and further comprising incrementally releasing a percentage of the funds to be paid for the modification of the resource upon completion of each of the plurality of conditions.

46. A method according to claim 45 wherein, upon completion of each of the plurality of conditions, the funds available to be paid for the modification of the resource are released to the at least one resource control client.

47. A method according to claim 37 wherein the resource includes at least one identifier related to the at least one resource control client;
and further comprising transmitting a notification to the at least one request client upon modification of the resource.

48. A method according to claim 37 wherein the resource includes at least one identifier relating to at least one account where the funds are to be deposited from escrow; and further comprising depositing the funds into the at least one account upon the at least one condition being met.

49. A method according to claim 48 wherein the at least one account includes a plurality of accounts; and further comprising depositing the funds into the plurality of accounts based on a predetermined percentage split among the plurality of accounts.

50. A method according to claim 37 wherein the at least one resource control client is selected from a group of resource control clients; and
wherein the at least one resource control client that is selected from the group of resource control clients is defined by the at least one resource control client that has the resource to be modified that matches the at least one condition.

51. A method according to claim 37 further comprising receiving the funds to be held in escrow from the at least one request client; receiving the at least one condition relating to the resource to be modified from the at least one request client; and searching for the resource to be modified that meets the at least one condition.
